(19) United States
(12) Patent Application Publication
(10) Pub. No.: US 2018/0149277 A1
(43) Pub. Date: May 31, 2018

(54) BARREL VALVE FOR GENERATION OF CUSTOMIZABLE PRESSURE WAVEFORMS

(71) Applicant: Nextern, Inc., White Bear Lake, MN (US)

(72) Inventor: Paul Hattan, Minneapolis, MN (US)

(21) Appl. No.: 15/824,874

(22) Filed: Nov. 28, 2017

Related U.S. Application Data
(60) Provisional application No. 62/428,333, filed on Nov. 30, 2016.

(51) Int. Cl. F16K 21/00; F16K 27/00; F16L 37/252

(52) U.S. Cl. CPC F16K 21/00; B05B 1/005; F16L 37/252; F16K 27/003

(57) ABSTRACT

Apparatus and associated methods relate to an apparatus for generating a periodic fluid pressure profile. The apparatus may include an enclosure extending longitudinally between an enclosure proximal end and an enclosure distal end. The enclosure may include a radial enclosure port. The apparatus may include an inner pressure profile module (IPPM) configured to rotate about a longitudinal axis and rotate inside of a longitudinally extending central cavity of the enclosure. The IPPM may include a radial IPPM aperture configured to longitudinally align with the radial enclosure port, and a longitudinally extending central cavity of the IPPM. The radial IPPM aperture may have a predetermined aperture shape. The apparatus may include a barrel configured to remain stationary in a longitudinally extending central cavity of the enclosure. The barrel may include a proximal radial barrel aperture and a distal radial barrel aperture.

### CROSS-REFERENCE TO RELATED APPLICATIONS

This application claims the benefit of U.S. Provisional Application Ser. No. 62/428,333, titled “Barrel Valve for Generation of Customizable Pressure Waveforms,” filed by Paul Hattan, on Nov. 30, 2016.

This application incorporates the entire contents of the foregoing application(s) herein by reference.

### TECHNICAL FIELD

Various embodiments relate generally to pressure valves.

### BRIEF DESCRIPTION OF THE DRAWINGS

FIG. 1A depicts a perspective view of an exemplary barrel valve.

FIG. 1B depicts an exploded view of an exemplary barrel valve.

FIG. 2 depicts a cross-sectional view of an exemplary barrel valve.

FIG. 3 depicts an exploded view of an exemplary barrel valve having four ports.

Like reference symbols in the various drawings indicate like elements.

### DETAILED DESCRIPTION OF ILLUSTRATIVE EMBODIMENTS

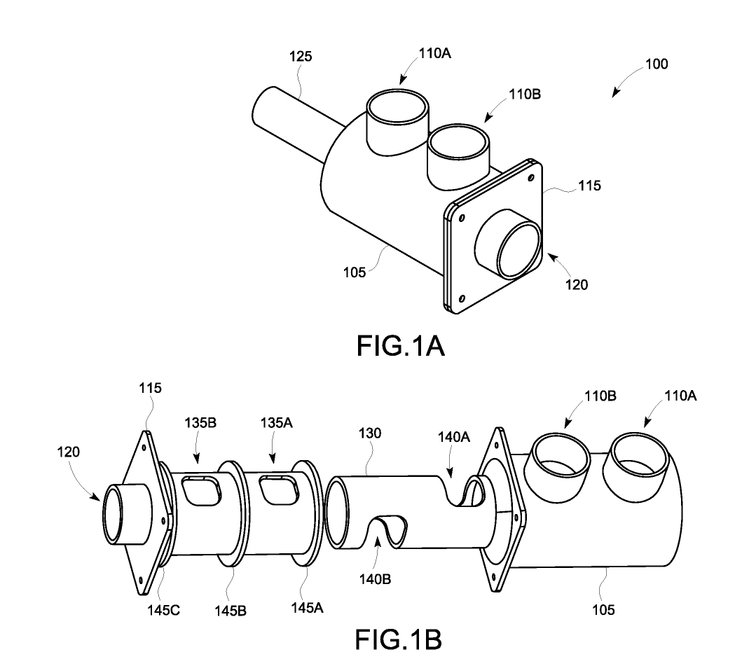

FIG. 1A depicts a perspective view of an exemplary barrel valve. A barrel valve 100 includes an enclosure 105. In this illustrative embodiment, the enclosure 105 has a cylindrical shape that extends along a longitudinal axis. At a proximal end of the enclosure 105 is a motor 125. Located on the top outer surface of the enclosure 105 is a proximal radial enclosure port 110A and a distal radial enclosure port 110B. Inside of the enclosure 105 is a barrel 115. Like the enclosure 105, the barrel 115 has a cylindrical shape that extends along the same longitudinal axis as the enclosure 105. At a distal end of the barrel 115 is a barrel distal end opening 120.

The barrel distal end opening 120 may be configured to be in fluid communication with a pressure source (e.g., an air blower). The pressure source may provide either (relative) positive or negative pressure at the barrel distal end opening 120. In some examples, a pressure source may be connected to any of the ports 110A or 110B. For example, a pressure source (e.g., air blower) may be connected on the port 110A, the port 110B may be open to the ambient environment, and the barrel distal end opening 120 may be connected to a pressure output destination. In various embodiments, multiple pressure sources may be connected to the ports 110A, 110B and/or the barrel distal end opening 120. For example, a first pressure source may be connected to the port 110A, a second pressure source may be connected to the barrel distal end opening 120, and the port 110B may be connected to a pressure output destination.

FIG. 1B depicts an exploded view of an exemplary barrel valve. This exploded view illustrated in FIG. 1B shows how the different parts of the barrel valve 100 are contained within one another. Inside of the enclosure 105 is the barrel 115. Inside of the barrel 115 is an inner pressure profile module (IPPM) 130. Like the enclosure 105 and the barrel 115, the IPPM 130 has a cylindrical shape that extends along the same longitudinal axis as the enclosure 105 and the barrel 115. The IPPM 130 is configured to rotate relative to the enclosure 105 and the barrel 115, with the enclosure 105 and the barrel 115 remaining stationary relative to one another. The barrel 115 includes a proximal radial barrel aperture 135A and a distal radial barrel aperture 135B. Similarly, the IPPM 130 includes a proximal radial IPPM aperture 140A and a distal radial IPPM aperture 140B.

In this illustrative embodiment, the radial barrel apertures 135A and 135B are configured to respectively align (both longitudinally and radially) with the radial enclosure ports 110A and 110B. The radial IPPM apertures 140A and 140B are configured to respectively align (longitudinally) with the radial enclosure ports 110A and 110B. In some examples, the motor 125 (FIG. 1A) may operatively couple to the proximal end of the IPPM 130 so that the motor 125 can impart rotational motion (around the longitudinal axis) to the IPPM 130.

A distal end of the IPPM 130 may operatively couple to a pressure source (e.g., air blower), so that an inner cavity of the IPPM may be in fluid communication with the pressure source. When the IPPM 130 rotates while coupled to the pressure source at the distal end of the IPPM 130, a unique pressure profile (e.g., pressure waveform) may be output at the radial enclosure ports 110A and 110B. The pressure profile/waveform at the radial enclosure ports 110A and 110B may be a function of at least: (1) the geometry/shape of the radial IPPM apertures 140A and 140B, (2) the geometry/shape of the radial barrel apertures 135A and 135B, (3) the frequency of rotation of the IPPM 130, and (4) the pressure level of the pressure source.

In some embodiments, a pressure source may be connected to any of the ports 110A or 110B. For example, a pressure source may be connected on the port 110B, the port 110A may be open to the ambient environment, and the distal end of the IPPM 130 may be connected to a pressure output destination. In various embodiments, multiple pressure sources may be connected to the ports 110A, 110B and/or the distal end of the IPPM 130. For example, a first pressure source may be connected to the port 110A, a second pressure source may be connected to the port 110B, and the distal end of the IPPM 130 may be connected to a pressure output destination. The ports 110A-B and or the distal end of the IPPM 130 may be connected to (multiple) pressure output destination(s). The pressure profile/waveform output to the pressure output destination may be a function of at least: (1) the geometry/shape of the radial IPPM apertures 140A and 140B, (2) the geometry/shape of the radial barrel apertures 135A and 135B, (3) the frequency of rotation of the IPPM 130, and (4) the pressure level of the pressure source(s).

The barrel 115 in this exemplary embodiment includes: (1) a first annular rib 145A extending around a radial outer perimeter of the barrel 115 and located in a proximal direction relative to the proximal radial barrel aperture, (2) a second annular rib 145B extending around the radial outer perimeter of the barrel 115 and located between the proximal radial barrel aperture 135A and the distal radial barrel aperture 135B, and (3) a third annular rib 145C extending around the radial outer perimeter of the barrel 115 and located in a distal direction relative to the distal radial barrel aperture 135B. The ribs 145A-145C define two annular chambers that are (pneumatically) isolated from one another. Accordingly, the ribs 145A-145C forming separate annular chambers aid in isolating the pressure being provided to the radial enclosure ports 110A and 110B.

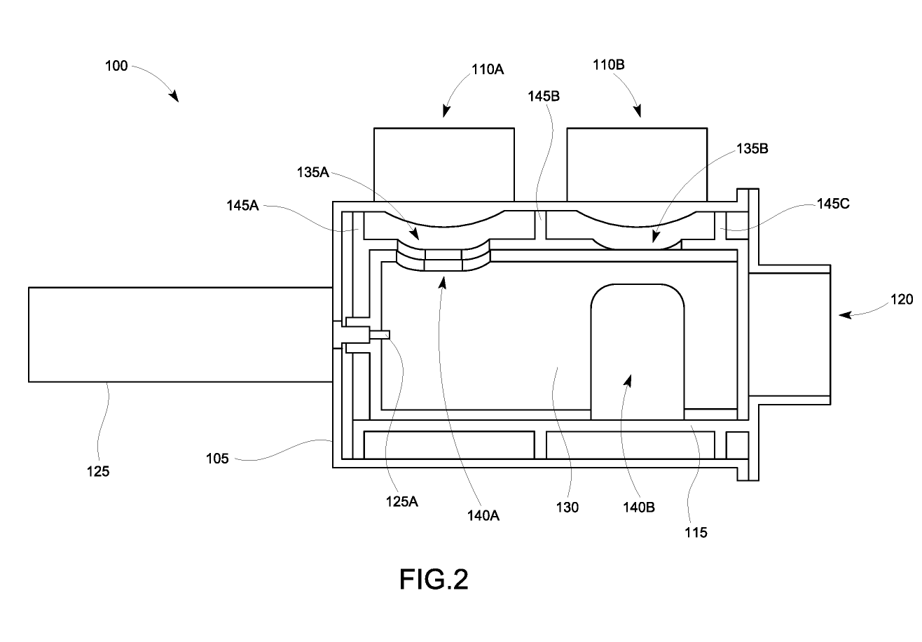

FIG. 2 depicts a cross-sectional view of an exemplary barrel valve. The barrel valve 100 includes the IPPM 130 enclosed inside of the barrel 115, the barrel being enclosed inside the enclosure 105. The motor 125 is operatively coupled to the IPPM 130 via a motor shaft 125a. The coupling between the motor shaft 125a and the IPPM 130 may be, for example, a threaded coupling. As the motor shaft 125a rotates, it imparts rotational motion on the IPPM 130. This rotational motion causes the radial IPPM apertures 140A and 140B to exhibit rotational motion. A pressure source in fluid communication with the barrel distal end opening 120 may cause a predetermined characteristic pressure waveform to be generated at the radial enclosure ports 110A and 110B when the IPPM rotates.

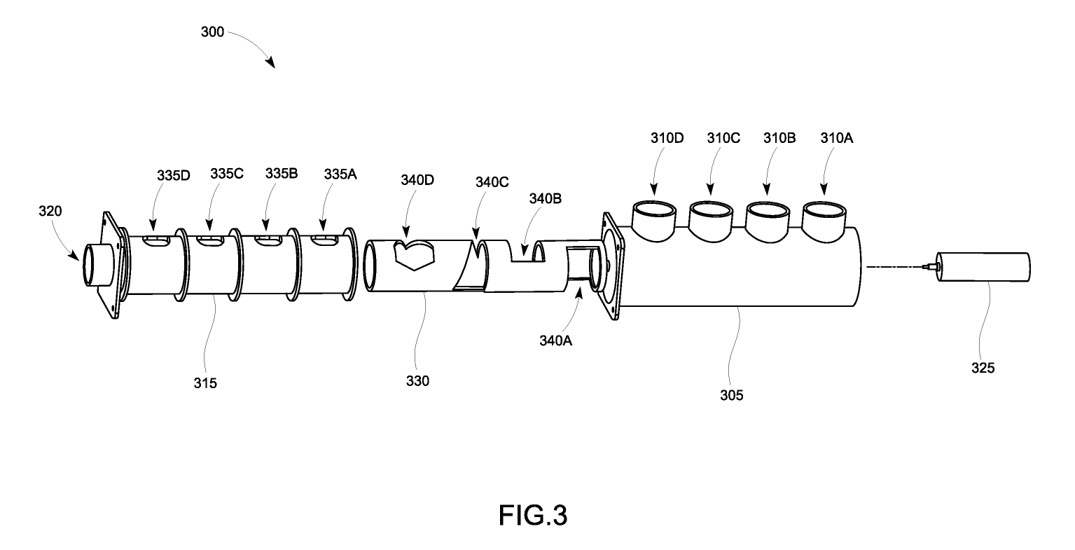

FIG. 3 depicts an exploded view of an exemplary barrel valve having four ports. A barrel valve 300 includes an enclosure 305. Located on the top outer surface of the enclosure 305 are four radial enclosure ports 310A-310D. Inside of the enclosure 305 is a barrel 315. The barrel 315 includes four radial barrel apertures 335A-335D. At a distal end of the barrel 315 is a barrel distal end opening 320.

The barrel distal end opening 320 may be configured to be in fluid communication with a pressure source (e.g., an air blower). A pressure source may be connected to any of the ports 310A-D. Multiple pressure sources may be connected to the ports 310A-D and/or the distal end of the IPPM 330. The ports 310A-D and or the distal end of the IPPM 330 may be connected to (multiple) pressure output destination(s).

At a proximal end of the enclosure 305 is a motor 325. The motor is operatively coupled to a proximal end of an IPPM 330. The IPPM 330 is configured to rotate relative to the enclosure 305 and the barrel 315, with the enclosure 305 and the barrel 315 remaining stationary relative to one another. The IPPM 330 includes four radial IPPM apertures 340A-340D. In this illustrative embodiment, two of the radial IPPM apertures 340A and 340B have the same shape profile (rectangular), while the other two radial IPPM apertures 340C and 340D have different shape profiles (triangular and polygonal, respectively). In some examples, a shape profile of an IPPM aperture may be non-linear. For example, an edge of the shape profile may have the form of an exponential curve.

Although various embodiments have been described with reference to the Figures, other embodiments are possible. For example, various structures may be employed for driving rotation of IPPM. In some examples, the IPPM may be driven by a hand crank. This may advantageously allow for a user to operate the barrel valve without a power supply. In some examples, a stepper motor may be employed to provide for controlled rotation of the IPPM. In various embodiments, various parts of the barrel valve may be manufactured using an injection molding process. In some examples, one radial enclosure port may be coupled to an output destination (e.g., a pressure vest), while another radial enclosure port may exhaust to an ambient external environment.

In various embodiments, radial apertures in the IPPM, barrel, and/or enclosure may be radially aligned with one another. In various embodiments, radial apertures in the IPPM, barrel, and/or enclosure may not be radially aligned with one another.

The barrel valve may be configured to produce a wide variety of pressure waveforms. For example, the pressure waveform output at one radial enclosure port may be a triangular wave, while the pressure waveform output at another radial enclosure port may be a sawtooth wave. A predetermined characteristic waveform may be an impulse waveform, which may provide for a concentrated pulse of pressure for a limited time duration. In some examples, a generated waveform may have the form of a step function, which may provide for discrete changes in pressure. Some pressure waveforms may have the form of a ramp wave, which may provide for a constant change in pressure with a jump in pressure change. In various embodiments, a generated pressure waveform may have the shape of a sinusoidal curve, which may provide for a smooth oscillating waveform. A generated pressure waveform may have an exponential rise/decline, which may provide for a wave with a predetermined time constant increase/decay.

An apparatus for generating a periodic fluid pressure profile may include an enclosure extending longitudinally between an enclosure proximal end and an enclosure distal end. The enclosure may include a radial enclosure port. The apparatus may include an inner pressure profile module (IPPM) configured to rotate about a longitudinal axis and rotate inside of a longitudinally extending central cavity of the enclosure. The IPPM may include a radial IPPM aperture configured to longitudinally align with the radial enclosure port, and a longitudinally extending central cavity of the IPPM. The radial IPPM aperture may have a predetermined aperture shape. In some examples, the barrel 115 may be an optional feature. For example, a device could be made with just the enclosure 105 and the IPPM 130.

Where the barrel is employed, it may contribute the following benefits. The barrel may allow the IPPM to communicate with the annular spaces anywhere in the full 360 degrees (e.g., “open” window alignment need not be aligned with the enclosure windows). The barrel may allow multiple windows in the barrel for a single annular space. This may permit, for example, (1) a pressure waveform output frequency that is a multiple of the motor spin frequency, (2) a pressure waveform output that is constant, and (3) better structural integrity of the barrel and IPPM (e.g., large windows might need longitudinal supports across them).

An apparatus for generating a periodic fluid pressure profile may include an enclosure extending longitudinally between an enclosure proximal end and an enclosure distal end. The enclosure may include a proximal radial enclosure port and a distal radial enclosure port. The apparatus may include a barrel having a barrel proximal end and a barrel distal end, the barrel configured to remain stationary in a longitudinally extending central cavity of the enclosure. The barrel may include a proximal radial barrel aperture configured to longitudinally align with the proximal radial enclosure port, and a distal radial barrel aperture configured to longitudinally align with the distal radial enclosure port. The apparatus may include an inner pressure profile module (IPPM) configured to rotate about a longitudinal axis and rotate inside of the longitudinally extending central cavity of the enclosure. The IPPM may include a proximal radial IPPM aperture configured to longitudinally align with the proximal radial enclosure port, a distal radial IPPM aperture configured to longitudinally align with the distal radial enclosure port, and a longitudinally extending central cavity of the IPPM. The proximal radial IPPM aperture may have a first predetermined aperture shape, and the distal radial IPPM aperture may have a second predetermined aperture shape.

In some examples, the first and second predetermined aperture shapes may be different shapes. The first predetermined aperture shape or the second predetermined aperture shape may be a polygonal shape. The first predetermined aperture shape or the second predetermined aperture shape may be a non-linear shape.

The apparatus may include a pressure source in fluid communication with the longitudinally extending central cavity of the IPPM. The pressure source may be an air blower or a vacuum pump. The apparatus may include a motor operatively coupled to an IPPM proximal end. The motor may be configured to rotate the IPPM about the longitudinal axis. In some embodiments, the proximal radial IPPM aperture and the distal radial IPPM aperture may be located at different radial angles along the IPPM.

In various examples, the barrel may include a first annular rib extending around a radial outer perimeter of the barrel and located in a proximal direction relative to the proximal radial barrel aperture. The barrel may include a second annular rib extending around the radial outer perimeter of the barrel and located between the proximal radial barrel aperture and the distal radial barrel aperture. The barrel may include a third annular rib extending around the radial outer perimeter of the barrel and located in a distal direction relative to the distal radial barrel aperture. In some embodiments, the first, second, and third annular ribs may sealingly engage an inner surface of the enclosure to form pneumatically isolated proximal and distal annular chambers.

A number of implementations have been described. Nevertheless, it will be understood that various modification may be made. For example, advantageous results may be achieved if the steps of the disclosed techniques were performed in a different sequence, or if components of the disclosed systems were combined in a different manner, or if the components were supplemented with other components. Accordingly, other implementations are within the scope of the following claims.

What is claimed is:

1. An apparatus for generating a periodic fluid pressure profile, the apparatus comprising:
an enclosure extending longitudinally between an enclosure proximal end and an enclosure distal end, the enclosure comprising a proximal radial enclosure port and a distal radial enclosure port;
a barrel having a barrel proximal end and a barrel distal end, the barrel configured to remain stationary in a longitudinally extending central cavity of the enclosure, the barrel comprising a proximal radial barrel aperture configured to longitudinally align with the proximal radial enclosure port, and a distal radial barrel aperture configured to longitudinally align with the distal radial enclosure port; and,
an inner pressure profile module (IPPM) configured to rotate about a longitudinal axis and rotate inside of the longitudinally extending central cavity of the enclosure, the IPPM comprising a proximal radial IPPM aperture configured to longitudinally align with the proximal radial enclosure port, a distal radial IPPM aperture configured to longitudinally align with the distal radial enclosure port, and a longitudinally extending central cavity of the IPPM, wherein the proximal radial IPPM aperture has a first predetermined aperture shape, and the distal radial IPPM aperture has a second predetermined aperture shape.

2. The apparatus of claim 1, wherein the first and second predetermined aperture shapes are different shapes.

3. The apparatus of claim 1, wherein the first predetermined aperture shape or the second predetermined aperture shape is a polygonal shape.

4. The apparatus of claim 1, wherein the first predetermined aperture shape or the second predetermined aperture shape is a non-linear shape.

5. The apparatus of claim 1, further comprising a pressure source in fluid communication with the longitudinally extending central cavity of the IPPM.

6. The apparatus of claim 5, wherein the pressure source comprises an air blower.

7. The apparatus of claim 5, wherein the pressure source comprises a vacuum pump.

8. The apparatus of claim 1, further comprising a motor operatively coupled to an IPPM proximal end, the motor configured to rotate the IPPM about the longitudinal axis.

9. The apparatus of claim 1, wherein the proximal radial IPPM aperture and the distal radial IPPM aperture are disposed at different radial angles along the IPPM.

10. The apparatus of claim 1, wherein the barrel further comprises:
a first annular rib extending around a radial outer perimeter of the barrel and disposed in a proximal direction relative to the proximal radial barrel aperture;
a second annular rib extending around the radial outer perimeter of the barrel and disposed between the proximal radial barrel aperture and the distal radial barrel aperture, and,
a third annular rib extending around the radial outer perimeter of the barrel and disposed in a distal direction relative to the distal radial barrel aperture,
wherein the first, second, and third annular ribs sealingly engage an inner surface of the enclosure to form pneumatically isolated proximal and distal annular chambers.

11. An apparatus for generating a periodic fluid pressure profile, the apparatus comprising:
an enclosure extending longitudinally between an enclosure proximal end and an enclosure distal end, the enclosure comprising a radial enclosure port;
an inner pressure profile module (IPPM) configured to rotate about a longitudinal axis and rotate inside of a longitudinally extending central cavity of the enclosure, the IPPM comprising a radial IPPM aperture configured to longitudinally align with the radial enclosure port, and a longitudinally extending central cavity of the IPPM, wherein the radial IPPM aperture has a predetermined aperture shape.

12. The apparatus of claim 11, wherein the predetermined aperture shape is a polygonal shape.

13. The apparatus of claim 11, wherein the predetermined aperture shape is a non-linear shape.

14. The apparatus of claim 11, further comprising a pressure source in fluid communication with the longitudinally extending central cavity of the IPPM.

15. The apparatus of claim 14, wherein the pressure source comprises an air blower.

16. The apparatus of claim 11, further comprising a motor operatively coupled to an IPPM proximal end, the motor configured to rotate the IPPM about the longitudinal axis.

17. An apparatus for generating a periodic fluid pressure profile, the apparatus comprising:
an enclosure extending longitudinally between an enclosure proximal end and an enclosure distal end, the enclosure comprising a proximal radial enclosure port, and a distal radial enclosure port;
a barrel having a barrel proximal end and a barrel distal end, the barrel configured to remain stationary in the longitudinally extending central cavity of the enclosure, the barrel comprising a proximal radial barrel aperture configured to longitudinally align with the proximal radial enclosure port, and a distal radial barrel aperture configured to longitudinally align with the distal radial enclosure port; and,
an inner pressure profile module (IPPM) configured to rotate about a longitudinal axis and rotate inside of a longitudinally extending central cavity of the enclosure, the IPPM comprising a proximal radial IPPM aperture configured to longitudinally align with the proximal radial enclosure port, a distal radial IPPM aperture configured to longitudinally align with the distal radial enclosure port, and a longitudinally extending central cavity of the IPPM, wherein the proximal radial IPPM aperture has a first predetermined aperture shape, and the distal radial IPPM aperture has a second predetermined aperture shape.
means for driving rotation of the IPPM about the longitudinal axis.

18. The apparatus of claim 17, wherein the first and second predetermined aperture shapes are different shapes.

19. The apparatus of claim 17, further comprising a pressure source in fluid communication with the longitudinally extending central cavity of the IPPM.

20. The apparatus of claim 17, further comprising a motor operatively coupled to an IPPM proximal end, the motor configured to rotate the IPPM about the longitudinal axis.
